(19) United States
(12) Patent Application Publication
(10) Pub. No.: US 2002/0128040 A1
(43) Pub. Date: Sep. 12, 2002

(54) Portable credit card and check verifying apparatus

(76) Inventors: James P. Romano, Syracuse, NY (US); Philip Anderson, Liverpool, NY (US)

Correspondence Address: HANCOCK & ESTABROOK, LLP, 1500 MONY Tower I, PO Box 4976, Syracuse, NY, 13221-4976, US

(21) Appl. No.: 10/067,462

(22) Filed: Feb. 5, 2002

Related U.S. Application Data
(63) Continuation-in-part of application No. 09/689,128, filed on Oct. 12, 2000.

(51) Int. Cl. H04M 1/00; H04B 1/38

(52) U.S. Cl. 455/556; 455/550

(57) ABSTRACT

Manually portable equipment for use at locations remote from a business promises or office for wireless credit card and/or check verification. The equipment includes a cell phone and/or wireless transceiver preferably capable of operation via direct satellite link, in addition to a terminal, interface, check reader, and printer, in various combinations. A rechargeable DC battery provides operating power to the components for a relatively long-time period.

### CROSS-REFERENCE TO PRIOR APPLICATION

The present application is a continuation-in-part of U.S. patent application, Ser. No. 09/689,128 filed Oct. 12, 2000.

### BACKGROUND OF THE INVENTION

The present invention relates to novel configurations of electronic communications apparatus, and more particularly to the field of apparatus having wireless credit card anc check verification ability with long, DC-powered operating life.

In many types of commercial transactions services are provided at, or products are delivered to a location where the customer is located, but which is remote from the usual business premises of the vendor. It is desirable in such situations that the delivery person or service provider have a portable and wireless means of verifying authorized credit access and accepting credit payment from the customer at the latter's location. An example of such equipment is found in U.S. Pat. No. 5,334,824 of Martinez, issued Aug. 2, 1994. This equipment operates from the DC power supply provided by the standard, built-in batteries which are removably positioned in and provide operating power to the cellular phone, requiring frequent recharging of the batteries in high volume applications. There is also the necessity in the usual apparatus of this type of providing terminal-to-phone interface circuitry. It is also desirable to have the capability in such portable apparatus of verifying the existence and solvency of checking accounts upon which checks tendered by the customer are drawn, as well as ensuring operational capability of the equipment at any location in the world.

The present invention is directed to overcoming one or more of the problems or disadvantages associated with the relevant technology.

### SUMMARY OF THE INVENTION

In a first embodiment, the apparatus of the present invention consists basically of a credit card terminal, a cellular telephone, a terminal/phone interface, a rechargeable battery power supply and, preferably, portable recharging equipment. The terminal is of a commercially available type and is connected to, or preferably includes, a printer. The cell phone is also conventional and is connected to the terminal via a direct connection of the terminal's RS 232 output port and the cell phone's RS 232 serial input port, providing direct digital/digital interface. The phone may be operated for a time by power from its built-in batteries, but is operated at least some times while connected to the portable power supply, thus simultaneously providing operating power to the phone and charging power to its batteries from the portable power supply. All elements of the apparatus may be conveniently packaged for portable use in a novel configuration upon a pair of mounting plates.

The RS 232-configured serial input port of the cell phone is normally used for connection to a hand set and the RS 232 digital output port of the terminal is normally intended for connection to the serial port on a laptop or desktop computer. In a second disclosed embodiment, the cell phone/radio is connected directly to the microcontroller of the terminal, thereby eliminating the need for the interface circuitry and modem. That data is exchanged directly between the terminal and phone via this connection.

A third embodiment includes a check reader and associated adapter interconnected with the other components to provide the capability of verifying that checks tendered by customers are in fact representative of active accounts and that the balance in the account at the time of verification is at least equal to the amount of the check. Also shown in connection with this embodiment, but capable of use with the others, is a system capable of operation from anywhere in the world.

### BRIEF DESCRIPTION OF THE DRAWING

FIG. 1 is a block diagram illustrating the components of the apparatus and their interconnection in a first embodiment;

FIG. 2 is a plan view of certain elements of the apparatus in a preferred mounting arrangement;

FIG. 3 is an end view of the elements of FIG. 2 and additional elements completing the basic units of the apparatus in the preferred mounting arrangement of this embodiment of the invention; and

FIGS. 4 and 5 are block diagrams illustrating the components of second and third embodiments respectively, of the invention and their manner of interconnection.

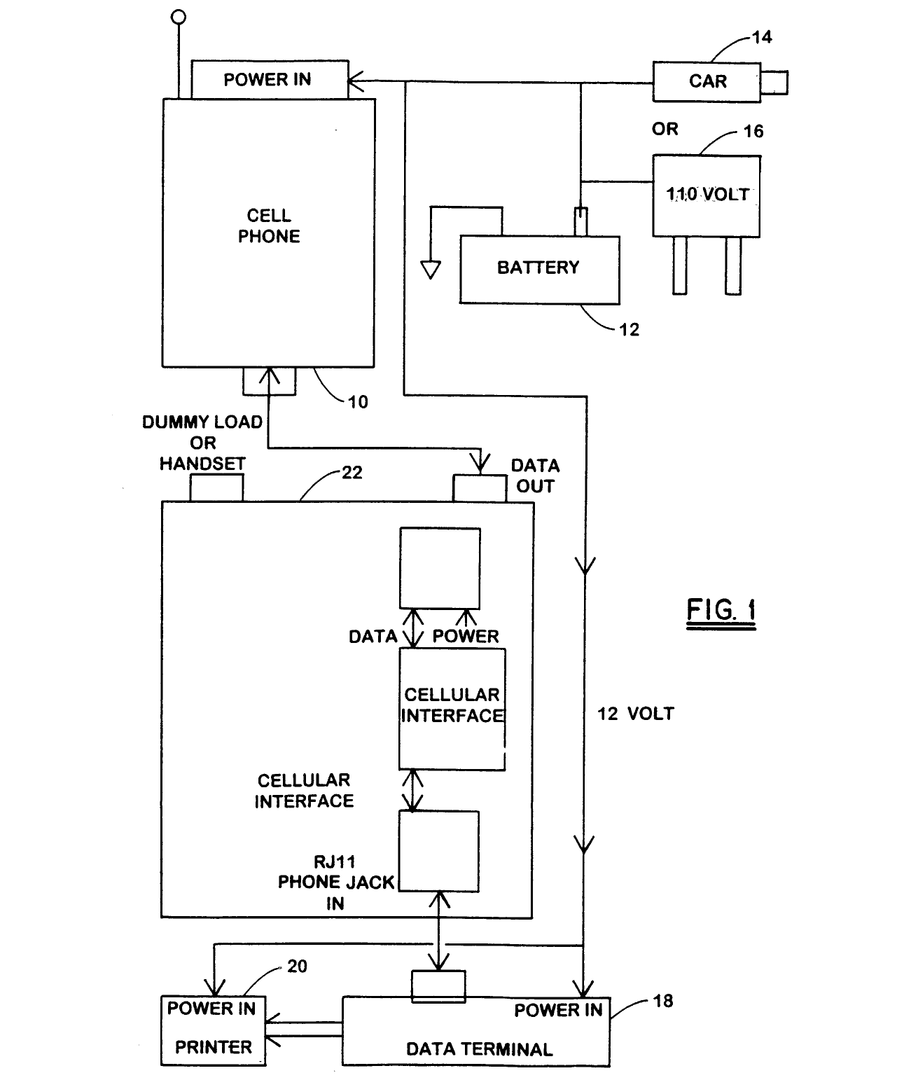

### DETAILED DESCRIPTION

Referring now to the drawing, the preferred components and electrical interconnections thereof are shown in block diagram form. Reference numeral 10 denotes an entirely conventional cellular telephone having the usual batteries within the phone housing for providing operating power to the phone for, at most, a few hours of on-line time. Cell phone 10 is connected, during at least some of its operating time, to external battery 12 which may be recharged by insertion of plug 14 into an automobile cigarette lighter receptacle, or by insertion of plug 16 into a standard, 1 lOv AC wall receptacle.

Data terminal 18 is also a conventional item and includes the usual slot or groove for swiping a magnetically coded credit card and/or other credit data entry means. Printer 20 is preferably connected to, or built into, terminal 18 to provide a permanently printed record of transactions at sites where conducted. Battery 12 also provides DC operating power to terminal 18 and printer 20. Cell phone 10 and terminal 18 are connected to one another through interface 22, also a conventional piece of equipment.

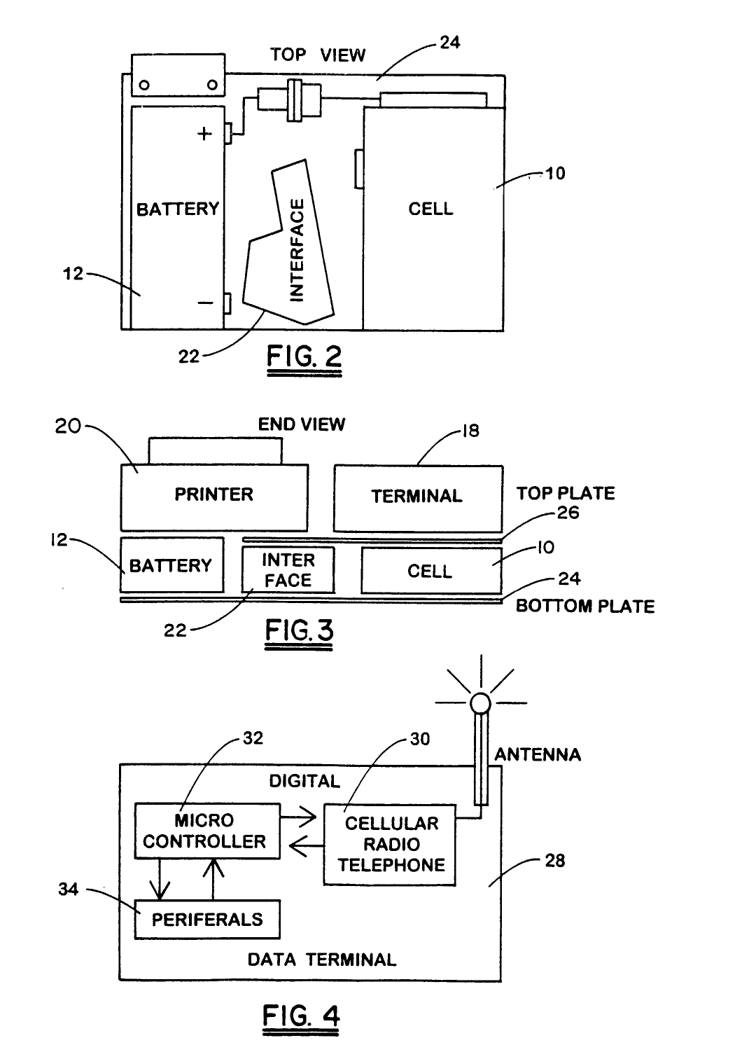

A preferred mounting arrangement for the above-described components is illustrated in FIGS. 2 and 3. Cell phone 10, battery 12 and interface 22 are either permanently or removably mounted upon a flat, bottom plate 24. Top plate 26 covers cell phone 10 and interface 22, and terminal 18 is mounted on the side of top plate 26 opposite cell phone 10. Printer 20 covers battery 12 and a portion of top plate 26 on the side opposite interface 22. Using present, commercially available components, bottom plate 24 may be on the order of 8 by 10 inches, and top plate 26 on the order of 8 by 7 inches. The entire assemblage of components may have a weight of a few pounds and may be carried in a backpack or pouch with shoulder strap.

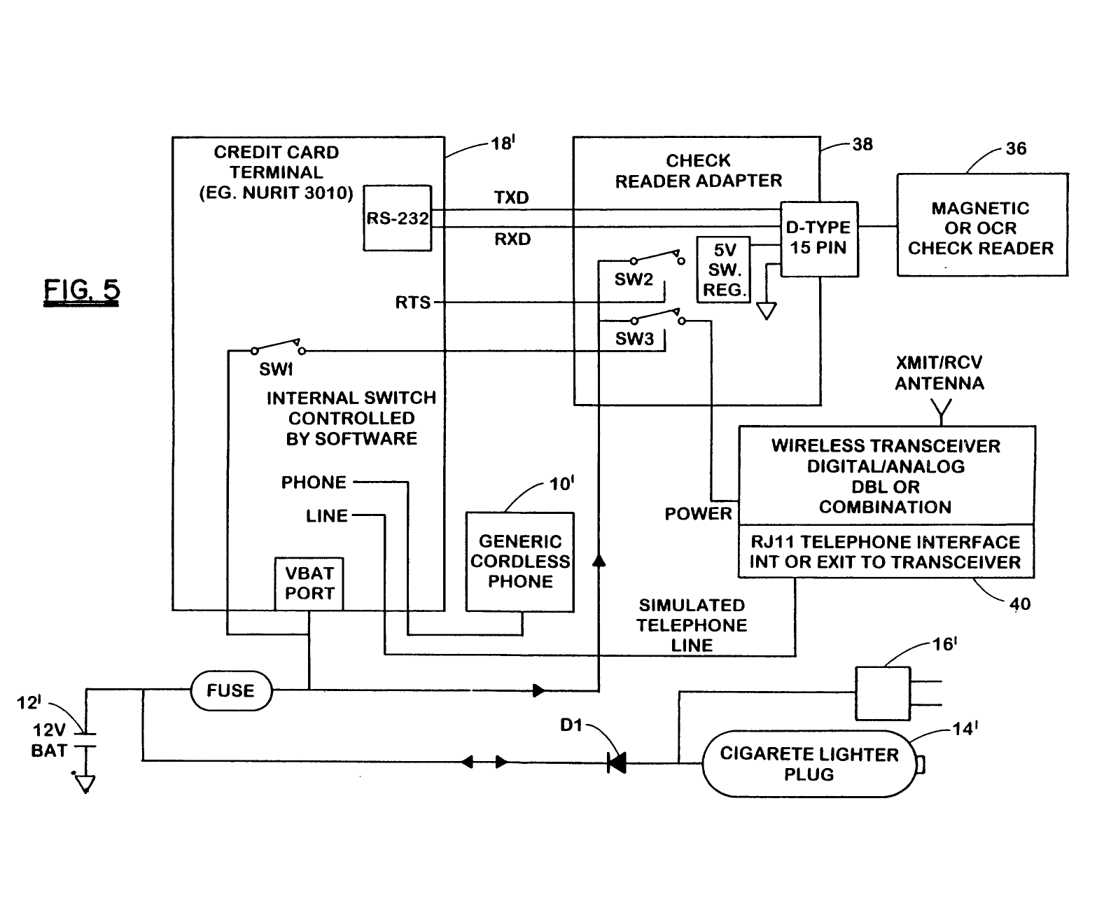

Turning now to FIG. 4, the invention is shown in another embodiment wherein a single data terminal 28 includes cellular radio/telephone 30, microcontroller 32 and printer and/or other peripheral equipment 34. Data is passed directly between phone 30 and controller 32, thereby eliminating the need for interface circuitry and modem which are employed in the preceding embodiment. This reduces both the cost and power requirements of the system.

A block diagram of a third embodiment, adding further capabilities to the previously disclosed embodiments, is shown in FIG. 5. Elements common to the first embodiment are denoted by the same reference numeral with a prime sign (′) added. These include cell phone 10 ′ battery 12′, lighter plug 14′ and wall plug 16′ for recharging the battery, and credit card terminal 18′. Also included are check reader 36 and check reader adapter 38 which operate in conventional manner to read a magnetic or bar code on a check The internal switches indicated at S1 in terminal 18 and at S2 and S3 in adapter are actuated by software in the course of system operation. Diode D1 is included to prevent discharge of battery 12′ through charging sources 14′ or 16′. Wireless transceiver 40 is preferably configured to operate on microwave frequencies to communicate via Direct Satellite Link (DSL) the uploaded and downloaded data associated with both credit card and check verification. In this manner, the system is capable of operation at essentially any location in the world in a self-contained package which is easily hand-carried, i.e., is manually portable.

What is claimed is:

1. Manually portable equipment for wireless transmission and reception of data for verification of credit and/or checking information, said equipment comprising:
a) a wireless transceiver;
b) a data terminal including at least one of credit and check data entry means;
c) a rechargable DC battery external to both said transceiver and said data terminal;
d) wiring connecting said battery to both said transceiver and said terminal; said battery providing the sole source of operating power to said transceiver and said data terminal.

2. The equipment of claim 1 wherein said transceiver is configured to communicate data via direct satellite link from essentially any location in the world.

3. The equipment of claim 2 wherein said terminal communication credit card data to said transceiver and receives responding credit card data from said transceiver.

4. The equipment of claim 2 including a check reader and associated check reader adapter for generating signals commensurate with indicia printed or encoded on a check and for applying said signals to said transceiver for transmission thereof as at least part of said data.

5. The equipment of claim 2 and further including a simulated telephone line connecting said terminal to said transceiver.

6. The equipment of claim 2 and further including a cordless telephone connected to said terminal.
